(19) United States
(12) Patent Application Publication
(10) Pub. No.: US 2025/0388742 A1
(43) Pub. Date: Dec. 25, 2025

(54) POLYMER COMPOSITION COMPRISING UHMWPE AND HDPE

(71) Applicants: SABIC GLOBAL TECHNOLOGIES B.V., Bergen op Zoom (NL); WISCONSIN ALUMNI RESEARCH FOUNDATION ("WARF"), Madison, WI (US)

(72) Inventors: Priya GARG, Vaals (NL); Thomas Daniel LANGSTRAAT, Leuven (BE); Martin Antonius VAN ES, Epen (NL); Kar-Man Raymond CHU, Maastricht (NL); Lih-Sheng TURNG, Madison, WI (US); Huaguang YANG, Guangzhou (CN); Galip YILMAZ, Izmir (TR)

(21) Appl. No.: 18/880,610

(22) PCT Filed: Jun. 27, 2023
(86) PCT No.: PCT/EP2023/067494

§ 371 Date: Jan. 2, 2025

(30) Foreign Application Priority Data
Jul. 1, 2022 (EP) 22182613.4

(51) Int. Cl. C08L 23/06; B29C 45/00; B29K 23/00; B29K 105/00

(52) U.S. Cl. CPC C08L 23/06; B29C 45/0001; B29K 2023/065; B29K 2023/0683; B29K 2105/0088; B29K 2995/0063; B29K 2995/0077; B29K 2995/0089

(57) ABSTRACT

The present invention relates to a polymer composition comprising ⋅ultra-high molecular weight polyethylene (UHMWPE) and ⋅≥5.0 and ≤50.0 wt %, preferably ≥5.0 and ≤40.0 wt % more preferably ≥5.0 and ≤30.0 wt %, even more preferably ≥5.0 and ≤20.0 wt %, of high-density polyethylene (HDPE) with regard to the total weight of the polymer composition; preferably wherein the HDPE is homopolymer of ethylene or a copolymer of ethylene and a comonomer, wherein the comonomer may be one selected from 1-butene, 1-hexene or 1-octene. Such polymer composition allows for being processed into desirable shaped objects using common and economically efficient shaping techniques, such as injection moulding and/or compression moulding.

### CROSS-REFERENCE TO RELATED APPLICATIONS

This application is a National Stage application of PCT/EP2023/067494, filed Jun. 27, 2023, which claims the benefit of European Application No. 22182613.4, filed Jul. 1, 2022, both of which are incorporated by reference in their entirety herein.

### BACKGROUND

The present invention relates to a polymer composition comprising ultra-high molecular weight polyethylene and high-density polyethylene. The invention also relates to a process for producing such composition, and to object produced using such composition.

Ultra-high molecular weight polyethylenes (UHMWPE) are a particular type of polyethylene materials that exhibit many outstanding properties, such as a high impact strength, a low friction coefficient, and good biocompatibility. These properties make UHMWPE a suitable material for use in applications such as bone joint prostheses, bearings, high-performance fibres, and pipes. UHMWPE typically have a very high molecular weight, long polymer chains, and a high degree of molecular entanglement.

However, the special molecular structure of UHMWPE may result in difficulties in processing the material via melt processing techniques. When the molecular weight of a polyethylene polymer is above 500,000 g/mol, the polymer retains its solid-state behaviour even at temperatures above its melting point, and thus does not exhibit appropriate fluid flow properties that would allow processing of the material via typical melt processing techniques in the field of thermoplastic polymers, such as melt extrusion and injection moulding.

To circumvent this, shaping processes of UHMWPE materials often involve solid powder processing techniques, such as compression moulding and ram extrusion. Each of these techniques however has its disadvantageous aspects. For example, compression moulding is a batch process, and thereby not particularly suitable for high-speed mass production of articles. Next to that, it involves a relatively long processing time, which may result in oxidative degradation of the UHMWPE material during the compression moulding process. And whilst ram extrusion is a quasi-continuous process, further machining of the obtained raw shapes, typically rods, is required, which tends to lead to machine marks on the surfaces of the produced part, which may affect the product aesthetics as well as the mechanical properties, and which leads to generation of waste material that is machined off from the ram extruded rods.

Other constraints to processing UHMWPE materials in common extrusion or injection moulding processes include for example the physical state of the UHMWPE materials that are available for processing. From the polymerisation process, the UHMWPE materials are obtained in a fine powdery form, having very low friction. When one attempts to process such powders via extrusion or injection moulding, the powders tend to rotate along with the rotating screw(s) inside the barrels of the extruder or injection moulding machine, and as a result thereof fail to be conveyed along the screw and move forward towards the die outlet of the extruder or the nozzle of the injection moulding machine. Accordingly, it is a challenging task to convert UHMWPE powders into more suitably handling materials, such as for example pellets. Pellets are in this context to be understood to be forms of the material having a size in millimetre (mm) range, such as 2-7 mm in diameter and 2-10 mm in length. Such pellets are often more convenient to process than powdery materials, and thereby desirable to have access to.

Accordingly, a desire exists to have access to more convenient processing methods for UHMWPE materials to produce objects of a desired shape, and in particular to method for producing pellets of UHMWPE.

### SUMMARY

In the field of polyethylenes, certain variation in nomenclature of the different types of polyethylenes is known to occur in literature. To avoid any unclarity in this regard, a specification of what constitutes UHMWPE is herewith provided. In the context of the present invention, an UHMWPE is to be understood as a polymer comprising recurring polymer units derived from ethylene, preferably consisting of recurring polymer units derived from ethylene, and having a viscosity average molecular weight (Mv) of at least 1,000,000 g/mol. Typical UHMWPE materials may have a viscosity average molecular weight in the range of 1,000,000 to 10,000,000 g/mol, or of 2,000,000 to 8,000,000 g/mol.

For the determination of the viscosity average molecular weight (Mv) of the UHMWPE materials, this is to be calculated in the context of the present invention based on the intrinsic viscosity (η) in dl/g, according to the Margolies equation:

$$Mv = 5.37 \cdot {10}^{4} \cdot {η}^{1.49}$$

Wherein Mv is the viscosity average molecular weight of the UHMWPE, in g/mol, and n is the intrinsic viscosity of the UHMWPE, in dl/g. The calculation according to the Margolies equation is described in ASTM D4020-11 (Standard Specification for Ultra-High Molecular Weight Polyethylene Molding and Extrusion Materials). The determination of the intrinsic viscosity is to be performed at a temperature of 135° C. in decalin as solvent, according to the method set out in ASTM D2857-95 (Re 2007) (Standard Practice for Dilute Solution Viscosity of Polymers).

The present invention provides for a polymer composition comprising
ultra-high molecular weight polyethylene (UHMWPE) and
≥5.0 and ≤50.0 wt % of high-density polyethylene (HDPE)
with regard to the total weight of the polymer composition.

Such polymer composition allows for being processed into desirable shaped objects using common and economically efficient shaping techniques, such as injection moulding and/or compression moulding.

### BRIEF DESCRIPTION OF THE DRAWINGS

A brief description of the drawings is provided herewith.

FIG. 1 presents a die assembly of a certain embodiment of the invention;

FIG. 2 presents an alternative configuration of the die assembly;

FIG. 3 shows a polymer extruder assembly comprising a die assembly according to the invention;

FIG. 4 shows a conventional die assembly, not comprising the compression zone as defined according to the present invention; and

FIG. 5 shows the content extruded from the barrel of the extruder by removal of the die from the extruder.

### DETAILED DESCRIPTION

The composition preferably comprises ≥5.0 and ≤40.0 wt % of the HDPE, more preferably ≥5.0 and ≤30.0 wt %, even more preferably ≥5.0 and ≤20.0 wt %, with regard to the total weight of the polymer composition. Alternatively, the composition preferably comprises ≥6.0 and ≤40.0 wt % of the HDPE, more preferably ≥6.0 and ≤35.0 wt %, even more preferably ≥15.0 and ≤35.0 wt %, with regard to the total weight of the polymer composition

The HDPE may for example have a molecular weight of ≥50,000 and ≤500,000 g/mol, preferably of ≥50,000 and ≤300,000 g/mol, more preferably of ≥75,000 and ≤250,000 g/mol.

The HDPE may be a homopolymer of ethylene, or a copolymer of ethylene and a comonomer. The comonomer may for example be one selected from 1-butene, 1-hexene or 1-octene. Such HDPE copolymer may for example comprise ≥0.1 and ≤5.0 wt % of polymeric units derived from the comonomer, with regard to the total weight of the HDPE copolymer, preferably ≥0.1 and ≤3.0 wt %, more preferably ≥0.3 and ≤3.0 wt %.

The HDPE may for example have a density of ≥946 and ≤975 kg/m³, preferably of ≥950 and ≤970 kg/m³, more preferably of ≥950 and ≤965 kg/m³, as determined in accordance with ASTM D792 (2008).

The HDPE may for example have a melt mass-flow rate of ≥0.1 and ≤100 g/10 min, as determined at 190° C. at 2.16 kg load in accordance with ASTM D1238 (2013), preferably of ≥0.5 and ≤50 g/10 min, more preferably of ≥1.0 and ≤25 g/10 min, even more preferably of ≥3.0 and ≤15.0 g/10 min, yet even more preferably of ≥5.0 and ≤10.0 g/10 min.

The UHMWPE may for example have a viscosity average molecular weight (Mv) of ≥ 2,000,000 g/mol, preferably of ≥2,000,000 and ≤8,000,000 g/mol, more preferably of ≥3,000,000 and ≤8,000,000 g/mol, even more preferably of ≥4,000,000 and ≤8,000,000 g/mol, yet even more preferably of ≥5,000,000 and ≤8,000,000 g/mol, wherein the Mv is calculated via the Margolies equation based on the intrinsic viscosity, wherein the intrinsic viscosity is determined at a temperature of 135° C. in decalin as solvent, according to the method set out in ASTM D2857-95 (Re 2007).

The UHMWPE may for example have a density of ≥900 kg/m³, preferably of ≥900 kg/m³ and ≤945 kg/m³, more preferably of ≥910 kg/m³ and ≤945 kg/m³, even more preferably of ≥910 kg/m³ and ≤935 kg/m³, yet even more preferably of ≥915 kg/m³ and ≤930 kg/m³.

The UHMWPE may be a homopolymer of ethylene or a copolymer of ethylene and a comonomer. The comonomer may for example be one selected from 1-butene, 1-hexene or 1-octene. Such UHMWPE copolymer may for example comprise ≥0.1 and ≤5.0 wt % of polymeric units derived from the comonomer, with regard to the total weight of the UHMWPE copolymer, preferably ≥0.1 and ≤3.0 wt %, more preferably ≥0.3 and ≤3.0 wt %.

The invention also relates to a polymer object comprising or consisting of the composition of any one of claims 1-5, wherein the object is a pellet having a diameter of 2-7 mm and a length of 2-10 mm, preferably having a diameter of 3-5 mm and a length of 4-6 mm. Such pellets allow for convenient moulding of articles and shapes using the polymer composition. In moulding, the use of mouldable polymer materials in the form of pellets is beneficial in view of the flow of the material into a moulding unit, when compared to use of powdery materials. Another advantage of the use of pellets is a reduce tendency for dusting, to which powdery materials are typically prone. It is preferred that in such object, the UHMWPE and the HDPE are distributed uniformly and indistinguishably.

It is preferred that the polymer composition comprises ≥95.0 wt % of the sum of the UHMWPE and the HDPE, with regard to the total weight of the polymer composition, or that the polymer composition consists of the UHMWPE, the HDPE and ≤1.0, preferably ≤0.5, wt % of additives.

Such pellets of the polymer composition according to the invention may for example be obtained by a process involving:
i. supplying to a polymer extruder assembly a polymer composition comprising an ultra-high molecular weight polyethylene (UHMWPE) and ≥5.0 and ≤50.0 wt %, preferably ≥5.0 and ≤40.0 wt % more preferably ≥5.0 and ≤30.0 wt %, even more preferably ≥5.0 and ≤20.0 wt %, of the HDPE, or ≥6.0 and ≤40.0 wt % of the HDPE, more preferably ≥6.0 and ≤35.0 wt %, even more preferably ≥15.0 and ≤35.0 wt %;
ii. conveying the polymer composition through the polymer extruder;
iii. conveying the polymer composition though the die assembly; and
iv. shaping the polymer composition that exited the polymer extruder via the outlet of the die assembly into pellets by either
   a) cooling the polymer composition to a temperature of below the melting temperature, preferably below 100° C., and subsequently cutting the obtained cooled strands into pellets; or
   b) cutting the polymer composition into pellets and subsequently cooling the pellets to below the melting temperature, preferably to below 100° C.;
wherein the polymer extruder assembly comprises a material inlet (6), an extruder barrel (7) comprising one or two extruder screws (8), and an outlet (9) for removing processed material from the extruder, wherein the outlet comprises the a die assembly comprises a circularly enclosed straight channel (1) comprising an inlet (2) and an outlet (3) construed so that matter may be conveyed through the channel from the inlet towards the outlet along a flow axis (4), wherein the channel comprises a housing (5) to form an enclosure fully enclosing the channel;
wherein the channel comprises a buffer section having a length A and a compression section having a length B, the buffer section positioned at the inlet side of the channel, and the compression section positioned at the outlet side of the channel, the buffer section and the compression section being connected to each other;
wherein the buffer section has a first diameter D1 perpendicular to the flow axis at the side of the inlet of the channel, and a second diameter D2 perpendicular to the flow axis at the side towards the outlet of the channel, wherein D1>D2, preferably to form a tapered channel section at an angle α;
wherein the compression section has a first diameter D3 perpendicular to the flow axis at the side towards the inlet of the channel that corresponds to D2, and a second diameter D4 perpendicular to the flow axis at the side of the outlet of the channel, wherein D3>D4 to form a tapered channel section at an angle β;
preferably wherein the angle α>β; and
preferably wherein D4 is a circular opening, more preferably wherein each of D1, D2, D3 and D4 are circular.

In the die assembly according to the invention, the angle β may preferably be ≥1.0° and ≤10.0°, preferably ≥1.5° and ≤. 5.0°.

It is preferred that the outlet diameter of the die assembly D4 is ≥2.0 and ≤8.0 mm, preferably ≥3.0 and ≤6.0 mm.

The length B of the compression section of the channel may for example be ≥20 and ≤ 100 mm, preferably ≥30 and ≤60 mm.

The ratio of the length B/length A may for example be ≥2.0, preferably ≥4.0.

The ratio of D3/D4 may for example be ≥1.2 and ≤2.0, preferably ≥1.3 and ≤1.7.

The die assembly according to the invention may be equipped with a cooling unit. Such cooling unit preferably may be configured so that it is capable of cooling the die assembly to a temperature of ≤150° C., more preferably of ≥100° C. and ≤150° C. The cooling unit may for example be a unit providing cooled air to the die assembly, preferably wherein the cooling unit is an air gun.

The die assembly may comprise multiple channels (1).

The invention, in certain embodiments, also related to a polymer extruder assembly comprising a material inlet (6), an extruder barrel (7) comprising one or two extruder screws (8), and an outlet (9) for removing processed material from the extruder, wherein the outlet comprises the die assembly according to the invention.

The extruder may comprise a cooling unit (10) for cooling the die assembly, preferably for cooling the die assembly to a temperature of ≤150° C., more preferably of ≥100° C. and ≤ 150° C. The cooling unit may for example be a unit providing cooled air to the die assembly, preferably wherein the cooling unit is an air gun.

It is preferred that the extruder barrel temperature in step ii) is ≥170° C. and ≤220° C. The extruder speed may for example be ≥50 and ≤150 rpm.

It is preferred that the pressure at the inlet of the die assembly is ≥3.0 and ≤8.0 MPa.

In a certain embodiment, the invention also relates to a process for production of a shaped article, wherein the process comprises compression moulding using the polymer object, the polymer object being the polymer pellets. It is preferred that such compression moulding is performed by feeding the polymer object into an open and heated mould cavity, followed by closing action of the two mould halves that provides compression and subsequent cooling to give the article the final shape.

The invention also relates to a compression moulded article comprising the polymer composition according to the invention, or produced using the polymer object according to the compression moulding process.

In a certain embodiment, the invention also relates to a process for production of a shaped article, wherein the process comprises injection moulding using the polymer object, the polymer object being the polymer pellets. It is preferred that such injection moulding is performed by melting the polymer object inside the machine barrel and then injecting the polymer melt under pressure into a closed cavity inside the mould where the polymer solidifies and forms the final article shaped by the cavity . . . .

The invention also relates to an injection moulded article comprising the polymer composition according to the invention, or produced using the polymer object according to the injection moulding process.

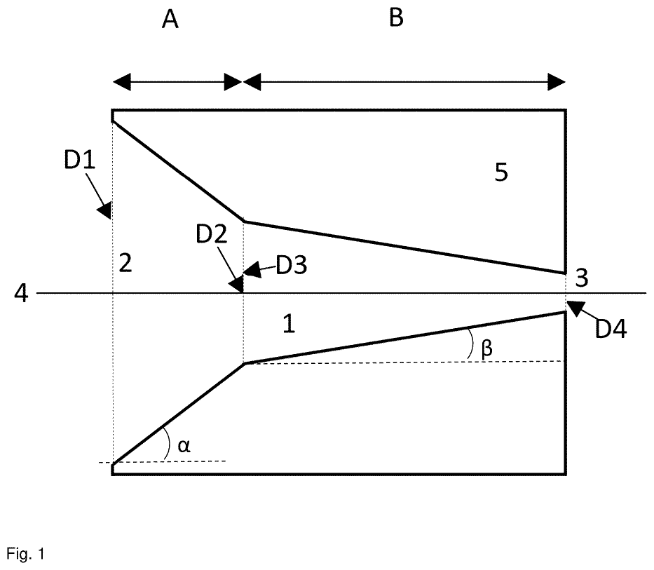

FIG. 1 presents a die assembly of a certain embodiment of the invention, comprising a tapered compression zone. In FIG. 1, the die assembly comprises a housing (5), comprising a channel (1), having an inlet (2) and an outlet (3). Material can flow along this channel in the direction of the flow axis (4). The assembly comprises a buffer zone having length A, and a compression zone having length B. D1 indicates the diameter of the entry of the buffer zone, and D2 the diameter of the outlet of the buffer zone; D3 indicates the diameter of the inlet of the compression zone, and D4 the diameter of the outlet of the compression zone.

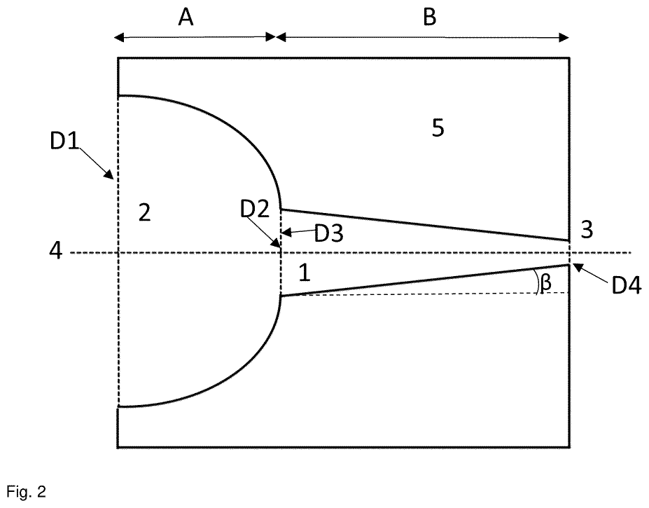

FIG. 2 presents an alternative configuration of the die assembly, showing an alternative geometry of the buffer zone. The indicators 1-5, A-B and D1-D4 of FIG. 2 correspond to those of FIG. 1 as explained above.

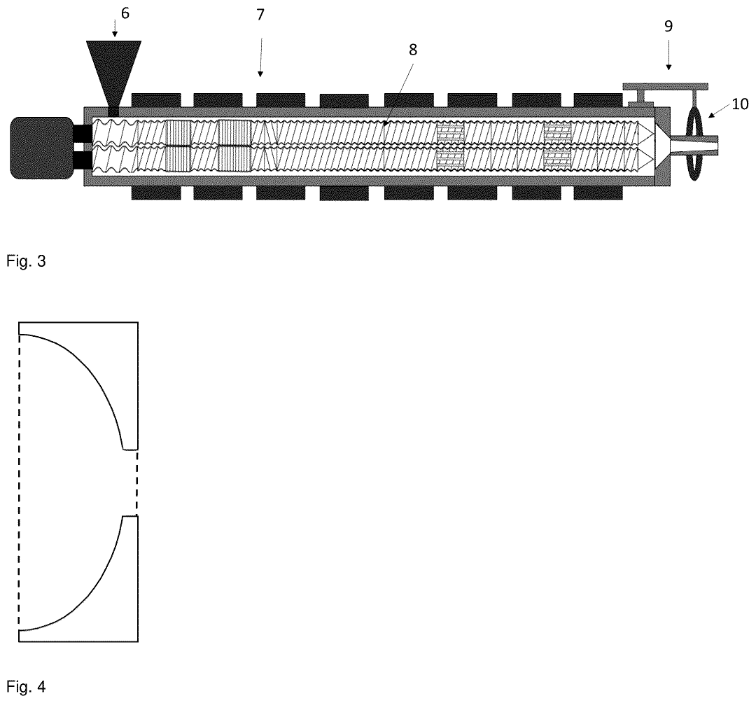

FIG. 3 shows a polymer extruder assembly comprising a die assembly according to the invention, wherein the extruder comprises a material inlet (6), an extruder barrel (7) comprising one or two extruder screws, and an outlet (9) for removing processed material from the extruder, wherein the outlet comprises the die assembly according to the invention. The extruder assembly of FIG. 3 further shows a cooling unit (10) for cooling the die assembly.

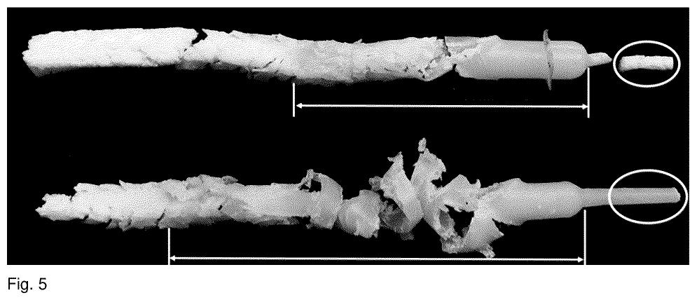

FIG. 4 shows a conventional die assembly, not comprising the compression zone as defined according to the present invention.

FIG. 5 shows the content extruded from the barrel of the extruder by removal of the die from the extruder, thereby reflecting the processing status of the content of the extruder during processing of the UHMWPE material. The top image in FIG. 5 shows the material as obtained from an extraction of the extruder content in the situation that the extruder was equipped with the conventional die assembly according to FIG. 4; the bottom image in FIG. 5 shows the material obtained in the situation that the extruder was equipped with the die assembly according to the present invention, using the configuration of FIG. 1.

The invention will now be illustrated by the following non-limiting examples.

A Leistritz ZSE-18 co-rotating twin-screw extruder was used in the examples of the present invention. The extruder was fitted with a tapered die, as shown in FIG. 1. The tapered die had a compression zone length of 35 mm, a tapered angle of the compression zone of 2°, and a diameter of the outlet opening of 4.5 mm. The extruder was operated at a temperature profile with each zone heated to 180° C., except for the die zone, which was heated to 170° C. The extruder was operated at a speed of 80 rpm. The feed rate of the polymer composition to the extruder was 0.53 kg/h. The extruder was equipped with an air gun to provide cooled air to the tapered die.

As materials, a UHMWPE having an Mv of 5,000,000 g/mol and a density of 920 kg/m³ was used, and SABIC CC860V, an HDPE having a density of 960 kg/m³, a melt mass-flow rate (190° C., 2.16 kg) of 7.6 g/10 min, and an Mv of 78,000 g/mol. All formulations that were produced comprised 0.5 wt % of antioxidant (Irganox 1010). The experimental formulations that were prepared are listed in the table below.

During extrusion, the pressure at the inlet of the die assembly, also referred to as the back pressure, was determined. The results thereof are presented in Table 1 below.

TABLE 1

| | | |
|---|---|---|
| Example | UHMWPE | HDPE |

| | | | | |
|---|---|---|---|---|
| 1 | 99.5 | wt % | 0 | wt % |
| 2 | 94.5 | wt % | 5.0 | wt % |
| 3 | 89.5 | wt % | 10.0 | wt % |
| 4 | 79.5 | wt % | 20.0 | wt % |
| 5 | 69.5 | wt % | 30.0 | wt % |
| 6 | 59.5 | wt % | 40.0 | wt % |
| 7 | 49.5 | wt % | 50.0 | wt % |
| 8 | 0 | wt % | 99.5 | wt % |

The products that were obtained were cut into pellets for further processing.

Samples of the product obtained in each example were subsequently processed into test samples via compression moulding using a CARVER press (1NE100). Pellets were placed between two steel plates. The compression moulding took place at 200° C., under a 10 MPa pressure, for 20 min.

Furthermore, samples of the product obtained in each example were subsequently processed into test samples via injection moulding using an Arburg Allrounder 270A machine with an ASTM D-638 Type V tensile test bar mould and an ASTM D-4020 impact test bar mould. Injection moulding was performed at a melt temperature of 235° C., and a mould temperature of 80° C. The injection speed was 20 cm³/s, and the injection pressure 1700 bar. The back pressure was 40 bar, the packing pressure 800 bar, and the packing time 20 s. The screw speed was 300 rpm.

Of the samples obtained via both compression moulding and injection moulding for each of the samples, the tensile strength and the impact strength were determined. The tensile strength was determined using an Instron 5967 test machine equipped with a 30 kN load cell according to the method of ASTM D638-14. Compression moulded samples as obtained via the method above were punched into Type V tensile bars for testing.

The impact strength was determined according to ASTM D4020-11 using double-notched Izod samples tested using a pendulum impact tester from Custom Scientific instruments Company with a pendulum of 5.4 J. The impact test samples with a thickness of 3 mm were machined from compression moulded sheets. The impact test samples from injection moulded examples were used as obtained via the method above. Impact strength testing was performed at both room temperature (23° C.) and at −40° C.

Results of tensile strength and impact strength testing are presented in Table 2 below, wherein CM means compression moulded samples and IM means injection moulded samples.

TABLE 2

| | Tensile | | Impact strength | | Impact strength | |
|---|---|---|---|---|---|---|
| | strength (MPa) | | (−40° C.) (kJ/m²) | | (23° C.) (kJ/m²) | |
| Example | CM | IM | CM | IM | CM | IM |
| 1 | 40.3 | 19.7 | 24 | 18 | 107 | 75 |
| 2 | 50.1 | 19.9 | 32 | 15 | 108 | 78 |
| 3 | 47.3 | 20.1 | 46 | 17 | 132 | 82 |
| 4 | 46.8 | 22.4 | 70 | 16 | 145 | 84 |
| 5 | 45.4 | 23.6 | 65 | 18 | 130 | 86 |
| 6 | 44.8 | 25.6 | 50 | 19 | 92 | 90 |
| 7 | 36.5 | 27.6 | 20 | 17 | 70 | 87 |
| 8 | 30.9 | 27.3 | 18 | 15 | 24 | 20 |

For determination of thermal properties of the materials, DSC analyses were performed on the materials of the examples. DSC analysis was performed using a TA Instruments Q20 equipment, according to ASTM F2625-10A standards. Samples of 5-10 mg were scanned from 30° C. up to 200° C. at a rate of 10° C./min in a nitrogen atmosphere, held 3 min before cooling down at 10° C./min to a temperature of 30° C., then subjected to a second heating at the same heating rate of 10° C./min again to 200° C. Calculation of degree of crystallinity (χ) was done according to the formula:

$$χ = ( \frac{Δ {H}_{f}}{Δ {H}_{f}^{0}} ) * 100 \%$$

wherein ΔH_{f}⁰=289.3 J/g, and ΔH_{f} for a given example was the enthalpy of crystallisation of the sample as obtained from the DSC measurement.

The results of the DSC measurements are presented in Table 3 below.

TABLE 3

| | Tₘ | | T_{c, onset} | T_{c, peak} | T_{c, offset} |
|---|---|---|---|---|---|
| Example | (° C.) | X (%) | (° C.) | (° C.) | (° C.) |
| 1 | 135.3 | 53.9 | 115.7 | 109.2 | 96.7 |
| 2 | 135.6 | 56.4 | 116.2 | 109.5 | 96.5 |
| 3 | 136.7 | 59.5 | 116.4 | 109.9 | 96.9 |
| 4 | 136.4 | 62.9 | 116.8 | 109.7 | 98.7 |
| 5 | 136.4 | 65.9 | 117.3 | 110.1 | 98.7 |
| 6 | 136.0 | 71.2 | 117.6 | 111.3 | 99.1 |
| 7 | 136.6 | 76.5 | 118.0 | 110.2 | 99.2 |
| 8 | 132.6 | 87.0 | 118.2 | 115.3 | 109.1 |

1. A polymer composition comprising
ultra-high molecular weight polyethylene (UHMWPE) and
≥5.0 and ≤50.0 wt % of high-density polyethylene (HDPE)
with regard to the total weight of the polymer composition.

2. The polymer composition according to claim 1, wherein the polymer composition comprises ≥95.0 wt % of the sum of the UHMWPE and the HDPE, with regard to the total weight of the polymer composition, or wherein the polymer composition consists of the UHMWPE, the HDPE and ≤1.0 wt % of additives.

3. The polymer composition according to claim 1, wherein the UHMWPE has a viscosity average molecular weight (Mv) of ≥2,000,000 g/mol, wherein the Mv is calculated via the Margolies equation based on the intrinsic viscosity, wherein the intrinsic viscosity is determined at a temperature of 135° C. in decalin as solvent, according to the method set out in ASTM D2857-95 (Re 2007).

4. The polymer composition according to claim 1, wherein the HDPE has a density of ≥946 and ≤975 kg/m³, as determined in accordance with ASTM D792 (2008).

5. The polymer composition according to claim 1, wherein the HDPE has:
· a molecular weight of ≥50,000 and ≤500,000 g/mol; and/or
a melt mass-flow rate of ≥0.1 and ≤100 g/10 min, as determined at 190° C. at 2.16 kg load in accordance with ASTM D1238 (2013).

6. A polymer object comprising or consisting of the composition of claim 1, wherein the object is a pellet having a diameter of 2-7 mm and a length of 2-10 mm.

7. The polymer object according to claim 6, wherein the UHMWPE and the HDPE are distributed uniformly and indistinguishably.

8. The polymer object according to claim 6, wherein the object is produced via a process involving:
i. supplying to a polymer extruder assembly a quantity of the UHMWPE and ≥5.0 and ≤50.0 wt %;
ii. conveying the polymer composition through the polymer extruder;
iii. conveying the polymer composition though the die assembly; and
iv. shaping the polymer composition that exited the polymer extruder via the outlet of the die assembly into pellets by either
a) cooling the polymer composition to a temperature of below the melting temperature and subsequently cutting the obtained cooled strands into pellets; or
b) cutting the polymer composition into pellets and subsequently cooling the pellets to below the melting temperature;
wherein the polymer extruder assembly comprises a material inlet (6), an extruder barrel (7) comprising one or two extruder screws (8), and an outlet (9) for removing processed material from the extruder, wherein the outlet comprises the a die assembly comprises a circularly enclosed straight channel (1) comprising an inlet (2) and an outlet (3) construed so that matter may be conveyed through the channel from the inlet towards the outlet along a flow axis (4), wherein the channel comprises a housing (5) to form an enclosure fully enclosing the channel;
wherein the channel comprises a buffer section having a length A and a compression section having a length B, the buffer section positioned at the inlet side of the channel, and the compression section positioned at the outlet side of the channel, the buffer section and the compression section being connected to each other;
wherein the buffer section has a first diameter D1 perpendicular to the flow axis at the side of the inlet of the channel, and a second diameter D2 perpendicular to the flow axis at the side towards the outlet of the channel, wherein D1>D2;
wherein the compression section has a first diameter D3 perpendicular to the flow axis at the side towards the inlet of the channel that corresponds to D2, and a second diameter D4 perpendicular to the flow axis at the side of the outlet of the channel, wherein D3>D4 to form a tapered channel section at an angle β.

9. A process for production of the polymer object according to claim 8, wherein the angle β is ≥1.0° and ≤10.0°.

10. A process for production of a shaped article, wherein the process comprises compression moulding using the polymer object according to claim 6.

11. The process according to claim 10, wherein the compression moulding is performed by feeding the polymer object into an open and heated mould cavity, followed by closing action of the two mould halves that provides compression and subsequent cooling to give the article the final shape

12. A compression moulded article comprising the polymer composition according to claim 1.

13. A process for production of a shaped article, wherein the process comprises injection moulding using the polymer object according to claim 6.

14. The process according to claim 13, wherein the injection moulding is performed by melting the polymer object inside the machine barrel and then injecting the polymer melt under pressure into a closed cavity inside the mould where the polymer solidifies and forms the final article shaped by the cavity.

15. An injection moulded article comprising the polymer composition according to claim 1.
